(19) United States
(12) Patent Application Publication
(10) Pub. No.: US 2017/0278260 A1
(43) Pub. Date: Sep. 28, 2017

(54) IMAGE PROCESSING APPARATUS, IMAGE PROCESSING METHOD, AND NON-TRANSITORY RECORDING MEDIUM STORING PROGRAM

(71) Applicant: Panasonic Intellectual Property Management Co., Ltd., Osaka (JP)

(72) Inventor: SHUHEI MATSUI, Osaka (JP)

(21) Appl. No.: 15/457,358

(22) Filed: Mar. 13, 2017

(30) Foreign Application Priority Data
Mar. 23, 2016 (JP) 2016-059241
Nov. 22, 2016 (JP) 2016-227198

(51) Int. Cl. G06T 7/60; G06T 7/00; G06T 7/73

(52) U.S. Cl. CPC G06T 7/60; G06T 7/73; G06T 7/97; G06T 2207/10028

(57) ABSTRACT

The processor calculates a first phase difference between a first light and a first reflection light, and a second phase difference between a second light and a second reflection light, generates a first distance image and a second distance using the first phase difference and the second phase difference, respectively, generates a first intensity image and a second intensity image for each of pixel of the first distance image and pixel of the second distance image, respectively, compares light receiving intensity for each pixel of the first intensity image with light receiving intensity for a corresponding pixel of the second intensity image, selects a pixel from the first distance image and a corresponding pixel of the second distance image based on the comparison, and generates a synthesized distance image using the selected pixels.

### BACKGROUND

1. Technical Field

The present disclosure relates to an image processing apparatus, an image processing method, and a non-transitory recording medium storing a program.

2. Description of the Related Art

Techniques of generating a distance image representing a distance to a three-dimensional object have been proposed. For example, there is a technique of generating a distance image using a distance measuring device with a time-of-flight (TOF) scheme. The distance measuring device with the TOF scheme uses a light source of infrared light or the like to measure a distance from the light source to an object by using a shift of a phase of light upon emission by the light source to a phase of reflection light from the object.

### SUMMARY

However, further improvement in the abovementioned technique has been required.

In one general aspect, the techniques disclosed here feature an image processing apparatus that includes: a light emitter that emits first light and second light at different timings towards an object present within an angle of view of the image processing apparatus, the first light emits a first light emission amount for a first exposure time, the second light emits a second light emission amount for a second exposure time, and the first and second light emission amounts or the first and second exposure times are different from each other; a light receiving sensor that receives first reflection light which is the first light reflected by the object, and second reflection light which is the second light reflected by the object; and a processor that calculates a first phase difference between the first light and the first reflection light, generates a first distance image using the first phase difference, generates a first intensity image in which light receiving intensity of the first reflection light received by the light receiving sensor is represented for each pixel of the first distance image, calculates a second phase difference between the second light and the second reflection light, generates a second distance image using the second phase difference, generates a second intensity image in which light receiving intensity of the second reflection light received by the light receiving sensor is represented for each pixel of the second distance image, compares the light receiving intensity for each pixel of the first intensity image with the light receiving intensity for a corresponding pixel of the second intensity image, selects a pixel from the first distance image and a corresponding pixel of the second distance image based on the comparison, and generates a synthesized distance image using the selected pixels.

These general and specific aspects may be implemented using a system, a method, and a computer program, and any combination of systems, methods, and computer programs.

The image processing apparatus and the like of the present disclosure makes it possible to generate a distance image with the stable distance accuracy.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram illustrating a configuration of a distance image generation device according to an embodiment;

FIG. 2 is a flowchart of distance image generation processing by the distance image generation device according to the embodiment;

FIG. 3 is a flowchart illustrating a detail of image capture processing in the distance image generation processing of FIG. 2;

FIG. 4 is a flowchart illustrating a detail of validity determination processing of a distance value in the distance image generation processing of FIG. 2;

FIG. 5 is a flowchart illustrating a detail of selection processing of a distance value in the distance image generation processing of FIG. 2;

FIG. 6 illustrates schematic views each illustrating examples of a distance image and an intensity image acquired by the distance image generation device according to the embodiment;

FIG. 7 illustrates schematic views illustrating examples of valid regions of the distance value for a distance image that is photographed while the light emission amount or the exposure time is changed for every image capturing frame;

FIG. 8 illustrates views illustrating examples of a data structure of a distance image captured by the distance image generation device according to the embodiment;

FIG. 9 illustrates views illustrating examples of a data structure of an intensity image captured by the distance image generation device according to the embodiment;

FIG. 10 illustrates views illustrating examples of a data structure of a distance image and an intensity image captured by the distance image generation device according to the embodiment; and

FIG. 11 is a view illustrating an example of a data structure of a synthesized distance image generated by the distance image generation device according to the embodiment.

### DETAILED DESCRIPTION

### (Underlying Knowledge Forming Basis of the Present Disclosure)

A distance measuring device with the TOF scheme measures a distance from a light source to an object using a shift of a phase of projection light by the light source to a phase of received reflection light that is the projection light reflected by the object. For example, when the projection light has a sufficiently large light amount, a distance from the light source to an object at a far distance can be measured with high accuracy, but a distance from the light source to an object at a near distance is difficult to measure accurately because the reflection light received reaches the saturated light amount. On the other hand, when the projection light has a small light amount, a distance from the light source to an object at a near distance can be measured accurately, but the reflection light from an object at a far distance has a light amount insufficient to measure the distance, thereby resulting in the calculated distance value with low accuracy. Moreover, the light amount of the light source is so small that the reflection light cannot be received, it is impossible to measure the distance. As in the foregoing, the light amount of the light source limits a range in which a distance from a light source to an object can be measured, and studies have been made on how to measure both a distance to an object at a far distance from the light source and a distance to an object at a near distance from the light source with high accuracy.

For example, a distance image camera disclosed in Japanese Unexamined Patent Application Publication No. 2012-225807 captures a distance image by projecting infrared light while changing the exposure setting, and receiving reflection light of the infrared light by an image sensor. The distance image camera stores distance data and light received level data for every pixel of each of the distance images with the different exposure settings. In the distance image camera, the pixels of the distance images with the different exposure settings are scanned while a scan target is changed from one pixel position to another to calculate weighting coefficients for the respective pixels. In addition, the distance data of the pixels of each pixel position are weighted with the calculated weighting coefficients and then are added up. In this way, a distance image is obtained in which the weighted average values are used as the distance data of the respective pixels at all the pixel positions. As a result, the distance image camera can obtain distance measurement results substantially across the entire distance image.

In the technique disclosed in Japanese Unexamined Patent Application Publication No. 2012-225807, weighted average processing for each pixel position is performed on the pixels in distance images captured at multiple timings. Thus, by stabilizing a measurement accuracy of a distance to an object present within an angle of view of image capture in that way, distance values are obtained across the wide range within the angle of view of image capture. However, the technique disclosed Japanese Unexamined Patent Application Publication No. 2012-225807 has a problem of outputting a distance image having blurring in a case where the position of the image sensor is shifted in the multiple timings, a case where an object present within the angle of view of image capture is moved, or other cases. Therefore, the inventors of the present disclosure have conceived the following improvement ways for improvement in distance image generation function.

(1) An image processing apparatus according to one aspect of the present disclosure includes: a light emitter that emits first light and second light at different timings towards an object present within an angle of view of the image processing apparatus, the first light emits a first light emission amount for a first exposure time, the second light emits a second light emission amount for a second exposure time, and the first and second light emission amounts or the first and second exposure times are different from each other;
a light receiving sensor that receives first reflection light which is the first light reflected by the object, and second reflection light which is the second light reflected by the object; and
a processor that calculates a first phase difference between the first light and the first reflection light, generates a first distance image using the first phase difference, generates a first intensity image in which light receiving intensity of the first reflection light received by the light receiving sensor is represented for each pixel of the first distance image, calculates a second phase difference between the second light and the second reflection light, generates a second distance image using the second phase difference, generates a second intensity image in which light receiving intensity of the second reflection light received by the light receiving sensor is represented for each pixel of the second distance image, compares the light receiving intensity for each pixel of the first intensity image with the light receiving intensity for a corresponding pixel of the second intensity image, selects a pixel from the first distance image and a corresponding pixel of the second distance image based on the comparison, and generates a synthesized distance image using the selected pixels.

With the abovementioned aspect, from the first and second distance images different in at least one of the light emission amount and the exposure time, a pixel with the higher light receiving intensity is extracted based on the values of light receiving intensity for every pair of pixels in the distance images, and a synthesized distance image is generated using the extracted pixels. For example, when a moving object is present in the distance images or when the image processing apparatus itself captures distance images while moving, a position of the object is moved between the first and second images. However, a pixel with the higher light receiving intensity has a higher accuracy of the distance value of the pixel, and thus use of a pixel of the distance image with higher light receiving intensity out of corresponding pixels in the first and second distance images to form a synthesized distance image makes it possible to prevent the synthesized distance image from including an obscure portion such as blurring. Therefore, a stable distance accuracy is obtained in the synthesized distance image.

(2) In the abovementioned aspect, the processor may extract a first pixel from the first distance image, the first pixel corresponding to a pixel having light receiving intensity of the first reflection light within a predetermined range in the first intensity image, extract a second pixel from the second distance image, the second pixel corresponding to a pixel having light receiving intensity of the second reflection light within the predetermined range in the second intensity image, compare the light receiving intensity within the predetermined range for the first pixel with the light receiving intensity within the predetermined range for the second pixel, based on the comparison, selects a pixel having higher light receiving intensity from the first pixel and the second pixel when both of the first pixel and the second pixel are valid pixels, and generate the synthesized distance image using the selected pixel having the higher light receiving intensity.

With the abovementioned aspect, it is possible to prevent generation of a synthesized distance image using a pixel in which the light receiving intensity of the reflection light is inadequate for calculation of a distance value of the distance image.

(3) In the abovementioned aspect, based on the comparison, when only one of the first pixel and the second pixel is a valid pixel, the processor may generate the synthesized distance image using the valid pixel among the first pixel and the second pixel.

With the abovementioned aspect, when only one valid pixel is present in the first and second distance images, it is impossible to compare the values of light receiving intensity. In this case, unless the valid pixel is used to form a synthesized distance image, many pixels may be missing in the synthesized distance image. The use of such only one valid pixel in the synthesized distance image can prevent the synthesized distance image from becoming obscure due to missing pixels.

(4) In the abovementioned aspect, the predetermined range may be equal to or more than a first threshold.

With the abovementioned aspect, the valid pixel corresponds to a pixel with light receiving intensity equal to or higher than the first threshold that is a lower limit value. Setting the lower limit value to, for example, low light receiving intensity that does not allow a distance value to be stably acquired can prevent each pixel in the synthesized distance image from having an inaccurate distance.

(5) In the abovementioned aspect, the predetermined range may be equal to or less than a second threshold.

With the abovementioned aspect, the valid pixel corresponds to a pixel with light receiving intensity equal to or lower than the second threshold that is an upper limit value. Setting the upper limit value to, for example, the saturated light receiving intensity that causes flared highlights in the reflection light can prevent each pixel in the synthesized distance image from having an inaccurate distance.

(6) In the abovementioned aspect, the predetermined range may be a range between a first threshold to a second threshold, both inclusive.

With the abovementioned aspect, the valid pixel corresponds to a pixel with light receiving intensity in the range of the first threshold that is a lower limit value to the second threshold that is an upper limit value, both inclusive. This can prevent each pixel in the synthesized distance image from having an inaccurate distance.

(7) An image processing method according to one aspect of the present disclosure includes: emitting first light and second light at different timings towards an object present within an angle of view of image capture, the first light emitting in a first light emission amount for a first exposure time, the second light emitting in a second light emission amount for a second exposure time, and the first and second light emission amounts or the first and second exposure times are different from each other; receiving first reflection light which is the first light reflected by the object, and second reflection light which is the second light reflected by the object; calculating a first phase difference between the first light and the first reflection light; generating a first distance image using the first phase difference; generating a first intensity image in which light receiving intensity of the received first reflection light is represented for each pixel of the first distance image; calculating a second phase difference between the second light and the second reflection light; generating a second distance image using the second phase difference; generating a second intensity image in which light receiving intensity of the received second reflection light is represented for each pixel of the second distance image; comparing the light receiving intensity for each pixel of the first intensity image with the light receiving intensity for a corresponding pixel of the second intensity image; selecting a pixel from the first distance image and a corresponding pixel of the second distance image based on the comparison; and generating a synthesized distance image using the selected pixels.

(8) A non-transitory recording medium according to one aspect of the present disclosure stores an image processing program. The program causes a processor to: emit first light and second light at different timings towards an object present within an angle of view of image capture, the first light emits in a first light emission amount for a first exposure time, the second light emits in a second light emission amount for a second exposure time, and the first and second light emission amounts or the first and second exposure times are different from each other; receive first reflection light which is the first light reflected by the object, and second reflection light which is the second light reflected by the object; calculate a first phase difference between the first light and the first reflection light; generate a first distance image using the first phase difference; generate a first intensity image in which light receiving intensity of the received first reflection light is represented for each pixel of the first distance image; calculate a second phase difference between the second light and the second reflection light; generate a second distance image using the second phase difference; generate a second intensity image in which light receiving intensity of the received second reflection light is represented for each pixel of the second distance image; compare the light receiving intensity for each pixel of the first intensity image with the light receiving intensity for a corresponding pixel of the second intensity image; select a pixel from the first distance image and a corresponding pixel of the second distance image based on the comparison; and generate a synthesized distance image using the selected pixels.

Note that, these overall or specific aspects may be implemented by a system, a method, an integrated circuit, a computer program or a computer readable recording medium such as a CD-ROM, or be implemented by arbitrary combination of the system, the method, the integrated circuit, the computer program, and the recording medium.

Hereinafter, embodiments are described in details with reference to the drawings. Note that, each embodiment described below indicates one specific example. Numerical values, shapes, materials, constituent elements, layout and connection form of the constituent elements, steps, and the order of the steps indicated in the following embodiments are merely examples, and are not intended to limit the scope of the present disclosure. Moreover, among constituent elements described in the following embodiments, those constituent elements that are not described in independent claims indicating the highest-level concepts of the present disclosure are described as arbitrary constituent elements.

### First Embodiment

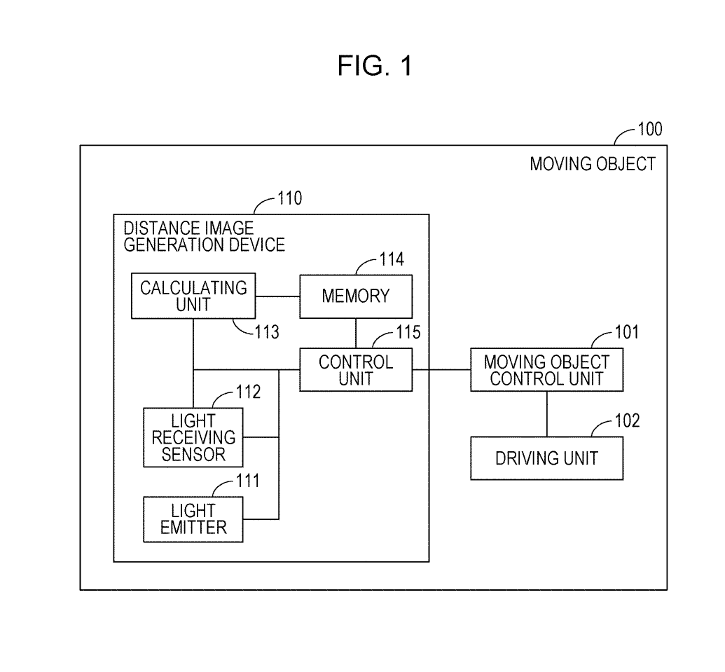

A configuration of a distance image generation device 110 according to an embodiment of the present disclosure will be described with reference to FIG. 1. FIG. 1 is a block diagram illustrating a configuration of the distance image generation device 110 according to the embodiment. The distance image generation device 110 measures a distance to an object within an angle of view of image capture, and generates a distance image on which a measurement result thereof is reflected. The distance image generation device 110 is mounted on a mobile object 100, for example, in the present embodiment. The distance image generation device 110 may be mounted on the mobile object 100 as a separate device and connected to the mobile object 100 via an interface or the like, or may configure a part of the mobile object 100. The mobile object 100 may be a device, such as a robot, that operates independently, or may be a device, such as a vehicle, that operates dependent on the handling, the operation, and the like by an operator.

The mobile object 100 provided with the distance image generation device 110, a mobile object control unit 101, and a driving unit 102. The distance image generation device 110 is provided with a light emitter 111, a light receiving sensor 112, a calculating unit 113, a memory 114, and a control unit 115. The distance image generation device 110 constitutes a TOF camera module that is incorporated into the mobile object 100 in the present embodiment. Note that, the TOF camera module may be configured by all of or a part of the light emitter 111, the light receiving sensor 112, the calculating unit 113, the memory 114, and the control unit 115.

The mobile object control unit 101 of the mobile object 100 controls the driving unit 102, and thus controls the movement, such as the movement amount, the movement speed, and the movement direction, of the mobile object 100. The mobile object control unit 101 transmits movement information related to the movement amount, the movement speed, the movement direction, and others of the mobile object 100, to the control unit 115 of the distance image generation device 110. The mobile object control unit 101 is configured to receive a distance image from the distance image generation device 110. The mobile object control unit 101 may control the movement of the mobile object 100 on the basis of the received distance image, for example, may detect an approach of the mobile object 100 to a surrounding object on the basis of the distance image and the movement information on the mobile object 100 and thus avoid a collision of the mobile object 100 with the object. The movement information on the mobile object 100 may be information calculated by the mobile object control unit 101 in order to control the driving unit 102, or may be information detected by a detector, which is not illustrated, disposed to the mobile object 100.

The driving unit 102 moves the mobile object 100 on the basis of instructions about the movement amount, the movement speed, the movement direction, and others received from the mobile object control unit 101. For example, when the mobile object 100 is provided with wheels, the driving unit 102 rotationally drives the wheels so as to meet the movement amount, the movement speed, the movement direction, and others thus instructed, and moves the mobile object 100. The driving unit 102 may be provided with, for example, a power device such as an electric motor or an electric actuator.

The light emitter 111 of the distance image generation device 110 is a light source that emits light to irradiate a space to be image captured with projection light. The light emitter 111 projects, for example, light with a phase, such as pulse light. As for the light emitter 111, for example, a light emitting diode (LED), a laser diode (LD), and the like that emit infrared rays can be employed, however, the light emitter 111 is not limited to these, but any element may be used as long as it emits light such as visible rays and ultraviolet rays. The light generated by the light emitter 111 may be diffused light in order to ensure an image capture range of the distance image. The light emitter 111 operates in accordance with the control by the control unit 115.

The light receiving sensor 112 receives light in synchronization with the timing when the light emitter 111 emits light. The light receiving sensor 112 generates an intensity image on the basis of the light receiving intensity that is detected by a light receiving element included in the light receiving sensor 112 when receiving light, and calculates the intensity image per pixel. The light receiving sensor 112 may be, for example, an image sensor. Examples of the image sensor include a complementary metal-oxide semiconductor (CMOS) image sensor or a charge coupled device (CCD) image sensor. The light receiving sensor 112 operates in accordance with the control by the control unit 115.

The calculating unit 113 calculates a distance value per pixel from information on the projection light by the light emitter 111 and the light receiving result by the light receiving sensor 112, and generates a distance image. The calculating unit 113 also generates an intensity image from the light receiving result by the light receiving sensor 112. The calculating unit 113 may acquire information on the projection light from the light emitter 111, the control unit 115, or the like, and acquire the light receiving result from the light receiving sensor 112. Moreover, the calculating unit 113 performs synthesis processing of a synthesized distance image using multiple pairs each having a distance image and an intensity image. In the synthesized distance image, a distance value obtained such that multiple distance values in corresponding pixels among the multiple distance images are synthesized is set as a distance of the pixel in the synthesized distance image. The calculating unit 113 may operate in accordance with the control by the control unit 115.

The memory 114 stores and keeps therein the multiple pairs of the distance images and the intensity images calculated by the light receiving sensor 112 for designated frames. The multiple pairs of the distance images and the intensity images kept in the memory 114 are used for the synthesis processing of a synthesized distance image performed by the calculating unit 113. The memory 114 is configured to receive and store therein information from the light emitter 111, the light receiving sensor 112, the calculating unit 113, the control unit 115, and the like, and allow the stored information to be derived by the calculating unit 113, the control unit 115, and the like. The memory 114 may be implemented by, for example, a semiconductor memory or a hard disk drive. The memory 114 may be a volatile memory or a nonvolatile memory.

The control unit 115 entirely controls an operation of the distance image generation device 110. The control unit 115 controls the light emission amount of the light emitter 111 and the exposure time of the light receiving sensor 112, and controls the timings when the light emitter 111 emits light and the timings when the light receiving sensor 112 receives light. For example, the control unit 115 may control, on the basis of the movement information on the mobile object 100 received from the mobile object control unit 101, the light emission amount of the light emitter 111, the exposure time of the light receiving sensor 112, and the timings at the light emission and the timings at the light reception. The control unit 115 may transmit the synthesized distance image generated by the calculating unit 113 to the mobile object control unit 101. Moreover, the control unit 115 may detect an approach of the mobile object 100 to a surrounding object on the basis of the synthesized distance image and the movement information on the mobile object 100, and transmit detection information to the mobile object control unit 101. Although the control unit 115 is provided separately from the mobile object control unit 101 in the present embodiment, the mobile object control unit 101 may also function as the control unit 115.

Components of the mobile object control unit 101, the calculating unit 113, the control unit 115, and the like may be configured by a computer system (not illustrated) including a central processing unit (CPU), a random access memory (RAM), and a read-only memory (ROM). A part of or all of the function of each component may be attained in such a manner that the CPU uses the RAM as a work memory to execute a program recorded on the ROM. Moreover, a part of or all of the function of each component may be attained by a dedicated hardware circuit. Note that, each component may be configured by a single element that performs a centralized control, or may be configured by multiple elements that perform a distributed control in cooperation with each other. A program may be provided as an application by the communication via a communication network such as the Internet, by the communication based on the mobile communication standard, or the like.

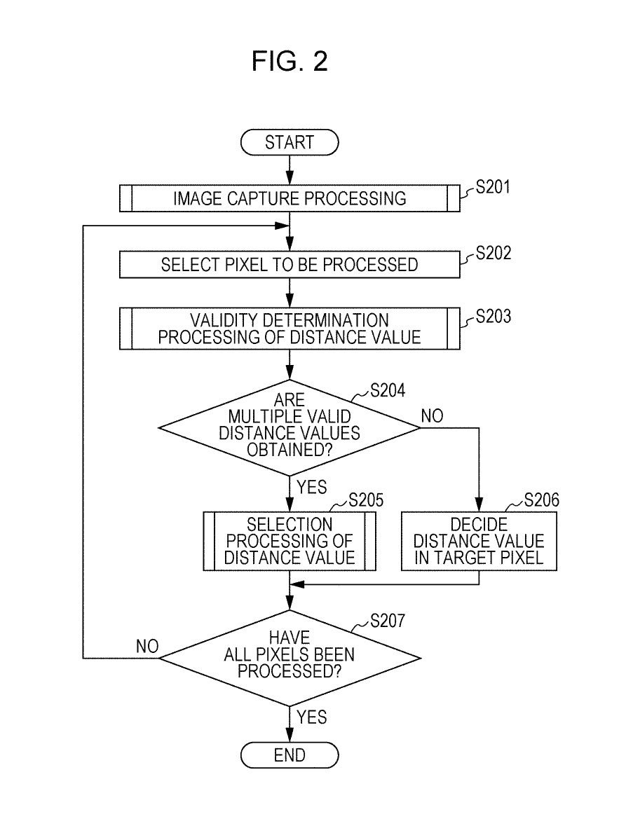

Next, an operation of the distance image generation device 110 according to the embodiment will be described with reference to FIGS. 1 and 2. FIG. 2 is a flowchart illustrating a flow of distance image generation processing by the distance image generation device 110 according to the embodiment.

The control unit 115 of the distance image generation device 110 performs image capture processing by controlling the light emitter 111 and the light receiving sensor 112 so as to meet an image capture condition that is changed for every image capturing frame (S201). The control unit 115 performs the image capture processing over multiple image capturing frames. The image capture condition is configured to include the light emission amount of the light emitter 111, the exposure time of the light receiving sensor 112, and movement information, such as the movement amount, the movement speed, the movement direction, and others, and other information on the driving unit 102 of the mobile object 100. The control unit 115 sets, on the basis of the movement information and other information on the driving unit 102, the light emission amount of the light emitter 111 and the exposure time of the light receiving sensor 112. In this case, the control unit 115 changes at least one of the light emission amount of the light emitter 111 and the exposure time of the light receiving sensor 112 so as to meet the image capture condition.

The distance image generation device 110 captures pairs of distance images and intensity images for multiple image capturing frames through the image capture processing. The number of the pairs of distance images and intensity images corresponds to the number of image capturing frames. A distance image herein indicates an image in which information on a distance from the distance image generation device 110 to an object present in an angle of view of image capture of the distance image generation device 110 is recorded for every pixel. The angle of view of image capture is, for example, a projection range of light by the light emitter 111. Moreover, the intensity image is an image in which intensity information on the received reflection light is recorded on each pixel of the intensity image that corresponds to each pixel of the distance image. The intensity image is used when a distance image is calculated. Therefore, the intensity image preferably has the number of pixels and the pixel arrangement the same as those of the distance image. A detail of the processing at Step S201 will be described later.

The distance image generation device 110 selects one target pixel to be processed for each of the captured multiple distance images (S202). Specifically, coordinates of the target pixel on the distance image are selected. Target pixels selected from multiple distance images are corresponding pixels among the multiple distance images. For example, corresponding target pixels among the multiple distance images may have the same coordinates. Alternatively, when the mobile object 100 is moved, a movement amount of the mobile object 100 among the distance images is considered, and thus target pixels the coordinates of which are shifted by the movement amount among the distance images may be selected so that the corresponding target pixels indicate the equivalent target in the respective distance images. A detail of the processing at Step S202 will be described later. Note that, the calculating unit 113 can perform the processing at Step S202 and the processing from Step S203 to Step S207, which is described later.

The distance image generation device 110 refers to, in an intensity image corresponding to each distance image, an intensity value of light indicated by a pixel having the same coordinates as the coordinates of the target pixel, and determines whether a distance value indicated by the target pixel in each distance image is valid. In other words, the distance image generation device 110 performs validity determination processing on a distance value of each target pixel (S203).

In the validity determination processing of a distance value, the validity of a distance value in the target pixel is determined on the basis of a determination on a possibility that the reflection light is saturated, a determination on the intensity of the reflection light, a determination on an S/N threshold value of the reflection light, and the like. When the distance value is not valid, in other words, is invalid, an invalid value is set to the target pixel. When the distance value is valid, a distance value in the target pixel is decided as a valid distance value. The S/N of the reflection light indicates the ratio of a signal (S) and noise (N) in the reflection light. For example, in a target pixel, when the reflection light may possibly be saturated, the intensity of the reflection light is equal to or less than an intensity threshold value and thus is too weak, or the S/N of the reflection light is equal to or less than a threshold value and thus noise is too much, the distance value in the target pixel is determined as an invalid value.

The distance image generation device 110 determines whether multiple valid distance values are obtained in the validity determination processing of distance values for the multiple target pixels (S204). If multiple valid distance values are obtained (YES at S204), the distance image generation device 110 performs distance value selection processing of selecting an optimal distance value out of the multiple valid distance values (S205). The distance image generation device 110 then applies the selected optimal distance value to a distance value in a target pixel in a synthesized distance image. A detail of the distance value selection processing will be described later.

On the other hand, if multiple valid distance values are not obtained (NO at S204), in other words, in a case where a valid distance value in a target pixel is obtained only from one distance image out of the multiple distance images or a case where distance values in the target pixels are invalid in all the multiple distance images, the distance image generation device 110 uniquely decides a distance value in the target pixel (S206). Specifically, in the case where a valid distance value in a target pixel is obtained only from one distance image out of the multiple distance images, the distance image generation device 110 decides the valid distance value as a distance value in the target image. The decided distance value in the target image is applied to a distance value in a target pixel in a synthesized distance image that is outputted in an image synthesis, which is described later, in which distance images and intensity images are used. Moreover, in the case where no valid distance value in the target pixel is obtained from any of multiple distance images, and all the distance values are invalid values, the distance image generation device 110 decides the distance value in the target pixel as an invalid value. The decided invalid value in the target pixel is applied to a distance value in a target pixel in a synthesized distance image as an invalid value.

The series of processing from Step S202 to Step S205/S206 is executed for all the pixels in the multiple distance images. Therefore, at Step S207 subsequent to Step S205 and S206, the distance image generation device 110 determines whether the processing from Step S202 to Step S205/S206 has been performed for all the pixels in the multiple distance images. If the abovementioned processing is completed for all the pixels (YES at S207), the distance image generation device 110 ends the distance image generation processing. If a pixel to which the abovementioned processing is performed is present (NO at S207), the distance image generation device 110 proceeds the processing to Step S202, and performs the processing from Step S202 to Step S205/S206 for an unprocessed pixel. In this manner, the distance image generation device 110 repeatedly executes the abovementioned series of the processing to each target pixel that is changed in turn until the series of the processing has completed for all the pixels in the multiple distance images. A distance value of each pixel that is obtained after the series of the processing for all the pixels in the multiple distance images have completed is then applied to a distance value of each pixel in a synthesized distance image, and as a result, all pixels in the synthesized distance image are formed.

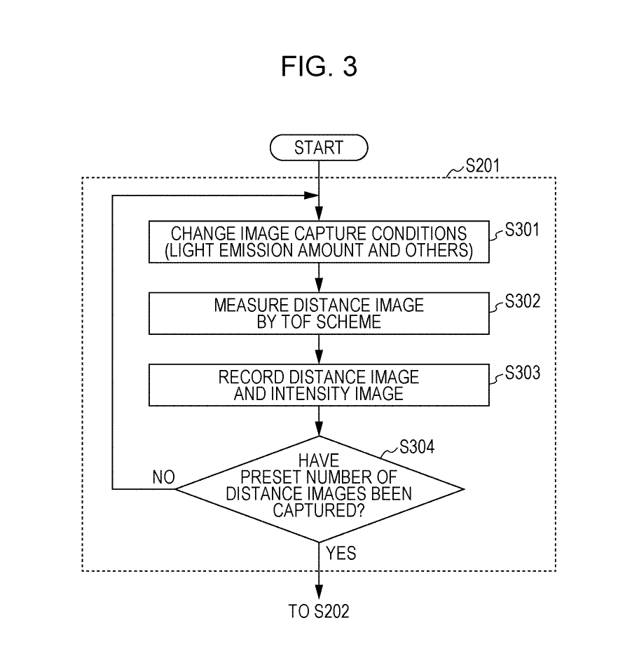

In addition, a detail of the image capture processing (S201) in the distance image generation processing of FIG. 2 will be described with reference to FIG. 3. FIG. 3 is a flowchart illustrating a detailed flow of the image capture processing in the distance image generation processing of FIG. 2. Firstly, the control unit 115 of the distance image generation device 110 changes already set image capture conditions of a distance image (S301). Here, the image capture conditions include the light emission amount of the light emitter 111, the exposure time of the light receiving sensor 112, and others. For example, the control unit 115 can change the image capture condition on the basis of movement information on the driving unit 102 of the mobile object 100, the luminance in the surroundings of the mobile object 100, and the like.

Next, the calculating unit 113 of the distance image generation device 110 acquires information on a phase of projection light that is generated due to the light emission by the light emitter 111 and information on a phase of reflection light that is the projection light being reflected by an object and is received by the light receiving sensor 112, and calculates a distance image using a difference between the acquired phases of the projection light and the reflection light (S302). In other words, the calculating unit 113 measures a distance image by the TOF scheme. In this example, the calculating unit 113 receives the information on a phase of projection light from the light emitter 111, and receives the information on a phase of reflection light from the light receiving sensor 112.

In addition, the calculating unit 113 stores the calculated distance image and an intensity image that is captured simultaneously with the distance image, in the memory 114 (S303). The intensity image that is captured simultaneously with the distance image indicates the intensity of the light received amount in each pixel of the intensity image, and the intensity of the light received amount in each pixel is the intensity of the reflection light the phase of which has been used for the calculation of the distance image.

Next, the control unit 115 determines whether the preset number of frames, in other words, the preset number of distance images are captured (S304). If the preset number of distance images have not been captured (NO at S304), the control unit 115 proceeds the processing to Step S301, changes the image capture condition to a next image capture condition, and captures a distance image and an intensity image. If the preset number of distance images have been captured (YES at S304), the control unit 115 proceeds the processing to Step S202. In this manner, the control unit 115 repeatedly measures a distance image until the number of distance images and the number of intensity images reach the preset number.

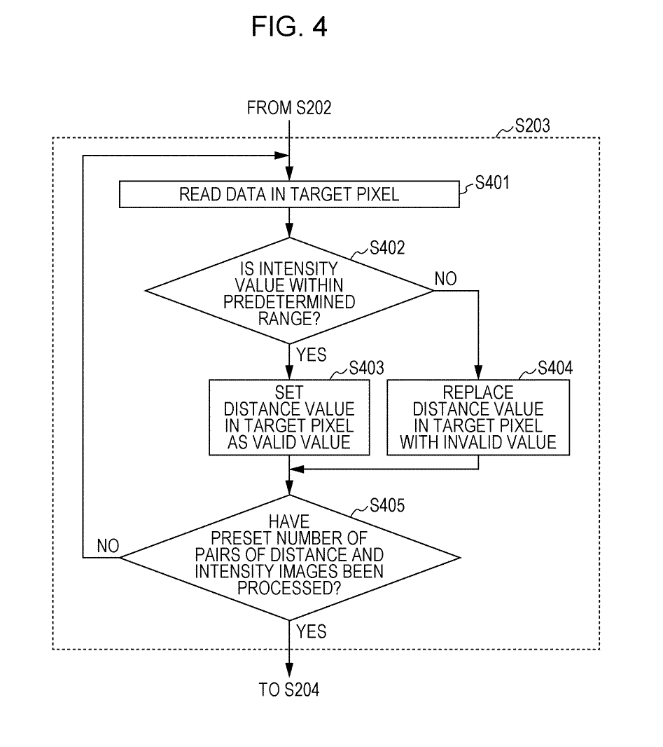

Next, a detail of the validity determination processing of a distance value (S203) in the distance image generation processing of FIG. 2 will be described with reference to FIG. 4. FIG. 4 is a flowchart illustrating a detailed flow of the validity determination processing of a distance value (S203) in the distance image generation processing of FIG. 2.

The calculating unit 113 of the distance image generation device 110 selects one pair out of the pairs of the distance images and the intensity images stored in the memory 114, and reads the distance value and the intensity value in the target pixel selected at Step S202 (S401). Here, when an intensity value indicated in a pixel of the intensity image is larger than a prescribed value, the light received amount may possibly be saturated. In other words, a distance value indicated in the corresponding pixel of the distance image may possibly be an unreliable value. Moreover, when an intensity value indicated in the pixel of the intensity image is smaller than a prescribed value, a distance value acquired with the light with too a small light received amount may possibly be unstable.

Therefore, the calculating unit 113 determines whether an intensity value indicated in the target pixel of the intensity image is a value within a predetermined range (S402). If the intensity value in the target pixel is not a value within the predetermined range (NO at S402), the calculating unit 113 decides a distance value in the corresponding target pixel of the distance image is not valid, replaces the distance value with an invalid value (S404), and proceeds the processing to Step S405. If the intensity value in the target pixel is a value within the predetermined range (YES at S402), the calculating unit 113 decides the distance value in the target pixel as a valid value (S403), and proceeds the processing to Step S405. The calculating unit 113 then determines whether the processing from Step S401 to Step S404 has been completed for the preset number of distance images and the preset number of intensity images (S405). If the processing for the preset number of distance images and the preset number of intensity images has been completed (YES at S405), the calculating unit 113 proceeds the processing to Step S204, whereas if not completed (NO at S405), the calculating unit 113 proceeds the processing to Step S401. The calculating unit 113 then performs the processing from Step S401 to Step S404 for an unprocessed pair of a distance image and an intensity image. In this manner, the calculating unit 113 repeats the abovementioned series of the processing for a target pixel until the calculating unit 113 executes the abovementioned series of the processing for the number of distance images and the number of intensity images, which are set for image capturing.

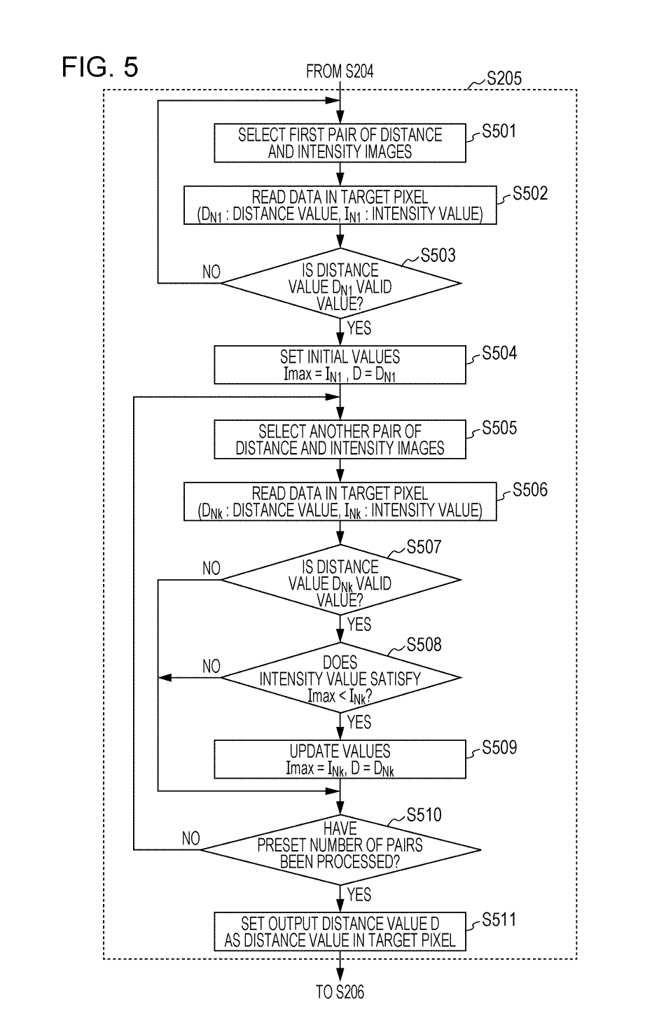

Next, a detail of the selection processing (S205) of a distance value in the distance image generation processing of FIG. 2 will be described with reference to FIG. 5. FIG. 5 is a flowchart illustrating a detailed flow of the selection processing (S205) of a distance value in the distance image generation processing of FIG. 2. When valid distance values are obtained in the aforementioned validity determination processing (S203) from multiple distance images in the target pixel selected at Step S202, the calculating unit 113 of the distance image generation device 110 executes processing, which is described later.

The calculating unit 113 firstly selects a first pair out of the multiple pairs of the distance images and the intensity images (S501). The calculating unit 113 then reads a distance value D_{N1} in a target pixel from the selected distance image, and reads an intensity value I_{N1} in a pixel corresponding to the target pixel from the selected intensity image (S502). In addition, the calculating unit 113 uses these read distance value D_{N1} and intensity value I_{N1} to determine whether the distance value D_{N1} is a valid value (S503). If the distance value is a valid value (YES at S503), the calculating unit 113 proceeds the processing to Step S504, whereas if the distance value is not a valid value (NO at S503), the calculating unit 113 proceeds the processing to Step S501, and selects a different pair of a distance image and an intensity image.

The calculating unit 113 then uses the distance value D_{N1} and the intensity value I_{N1} to initialize an output distance value D and a maximum intensity value Iₘₐₓ (S504). In other words, the calculating unit 113 respectively decides the read distance value D_{N1} and the read intensity value I_{N1} as initial values of the output distance value D and the maximum intensity value Iₘₐₓ.

The calculating unit 113 then selects another pair of a distance image and an intensity image (S505). In addition, the calculating unit 113 reads a distance value D_{Nk} in the target pixel from the selected distance image, and reads an intensity value I_{Nk} in the corresponding pixel from the selected intensity image (S506).

The calculating unit 113 determines whether the read distance value D_{Nk} is a valid value (S507). If the distance value D_{Nk} is a valid value (YES at S507), the calculating unit 113 proceeds the processing to Step S508, whereas if the distance value D_{Nk} is not a valid value (NO at S507), the calculating unit 113 proceeds the processing to Step S510.

At Step S508, the calculating unit 113 compares the currently set maximum intensity value Iₘₐₓ with the newly acquired the intensity value I_{Nk}. If the intensity value I_{Nk} is larger than the maximum intensity value Iₘₐₓ (YES at S508), the calculating unit 113 respectively updates the output distance value D and the maximum intensity value Iₘₐₓ to the newly acquired distance value D_{Nk} and the newly acquired intensity value I_{Nk} (S509). If the intensity value I_{Nk} is smaller than the maximum intensity value Iₘₐₓ (NO at S508), the calculating unit 113 proceeds the processing to Step S510.

At Step S510, the calculating unit 113 determines whether the processing from Step S505 to Step S509 has been completed for the preset number of distance images and the preset number of intensity images (S510). If the processing for both of the preset number of distance images and the preset number of intensity images has been completed (YES at S510), the calculating unit 113 proceeds the processing to Step S511, and sets the currently set output distance value D as an optimal distance value in the target pixel (S511). If the processing for both of the preset number of distance images and the preset number of intensity images has not been completed (NO at S510), the calculating unit 113 proceeds the processing to Step S505, and performs the processing from Step S505 to Step S509 for an unprocessed pair of a distance image and an intensity image. The calculating unit 113 repeats the abovementioned series of the processing for a target pixel until the calculating unit 113 executes the abovementioned series of the processing for the preset number of distance images and the preset number intensity images. After the completion of the processing for the preset number of distance images and the preset number intensity images, the calculating unit 113 outputs the currently set output distance value D as an optimal distance value in the target pixel of a distance image to be outputted, in the same manner as in Step S511.

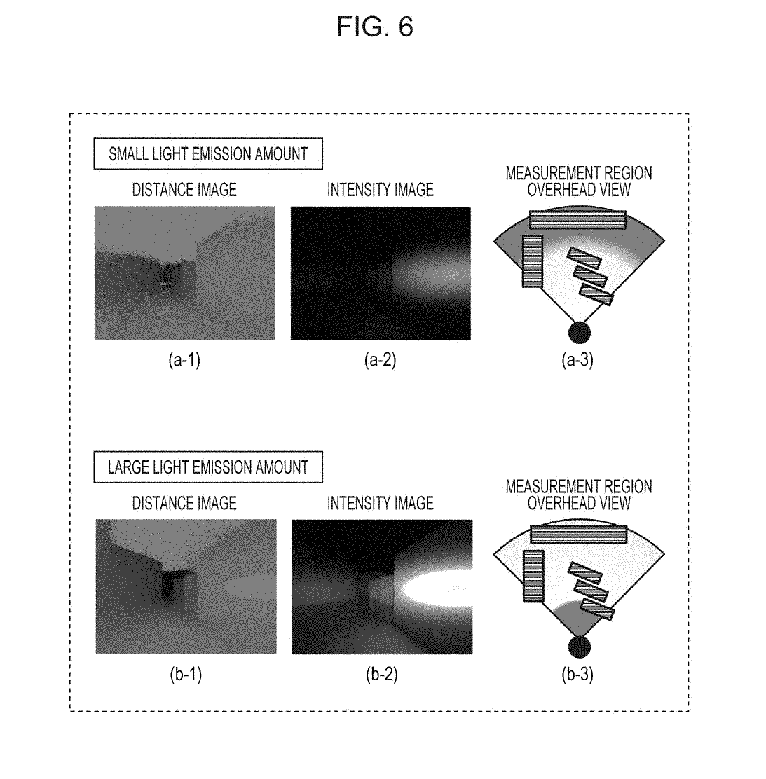

Next, examples of a distance image, an intensity image, and a synthesized distance image, which are captured by the distance image generation device 110 according to the embodiment, and an example in which the distance image generation device 110 captures a synthesized distance image from the distance image and the intensity image will be described. FIG. 6 illustrates schematic views illustrating examples of a distance image and an intensity image captured by the distance image generation device 110 according to the embodiment.

FIG. 6(a-1) illustrates an example of a distance image that is measured under such an image capture condition that the light emission amount by the light emitter or the exposure time by the light receiving sensor is smaller or shorter than a predetermined value. In this example, an object farther from the light receiving sensor is represented by a color with lower lightness. FIG. 6(a-2) illustrates an example of an intensity image that is measured under such an image capture condition that the light emission amount by the light emitter or the exposure time by the light receiving sensor is smaller or shorter than a predetermined value. In this example, a place with larger light received amount, that is, intensity, is represented by a color with higher lightness. FIG. 6(a-3) illustrates an overhead view of an image capture environment for capturing the images of FIGS. 6(a-1) and 6(a-2). A black circle indicates a position of the light receiving sensor, a fan-shaped region extended from the light receiving sensor indicates an angle of view of image capture of the light receiving sensor, and rectangular areas present within the fan-shaped region indicate objects, in the drawing. Moreover, a colorless region within the fan-shaped region indicating the angle of view of image capture indicates a valid region where a distance value that is a valid value is obtained, and a colored region within the fan-shaped region indicates an invalid region where a distance value is an invalid value.

FIG. 6(b-1) illustrates an example of a distance image that is measured under such an image capture condition that the light emission amount by the light emitter or the exposure time by the light receiving sensor is larger or longer than a predetermined value. In this example, an object farther apart from the light receiving sensor is represented by a color with lower lightness. FIG. 6(b-2) illustrates an example of an intensity image that is measured under such an image capture condition that the light emission amount by the light emitter or the exposure time by the light receiving sensor is larger or longer than a predetermined value. In this example, a place with larger light received amount is represented by a color with higher lightness. FIG. 6(b-3) illustrates an overhead view of an image capture environment for capturing the images of FIGS. 6(b-1) and 6(b-2). A black circle indicates a position of the light receiving sensor, a fan-shaped region extended from the light receiving sensor indicates an angle of view of image capture of the light receiving sensor, and rectangular areas present within the fan-shaped region indicate objects, in the drawing. Moreover, within the fan-shaped region indicating the angle of view of image capture, a colorless region indicates a valid region of a distance value and a colored region indicates an invalid region of a distance value.

As illustrated in FIG. 6, a region where a valid value for the distance value can be acquired in the distance image is changed depending on the difference in the light emission amount by the light emitter.

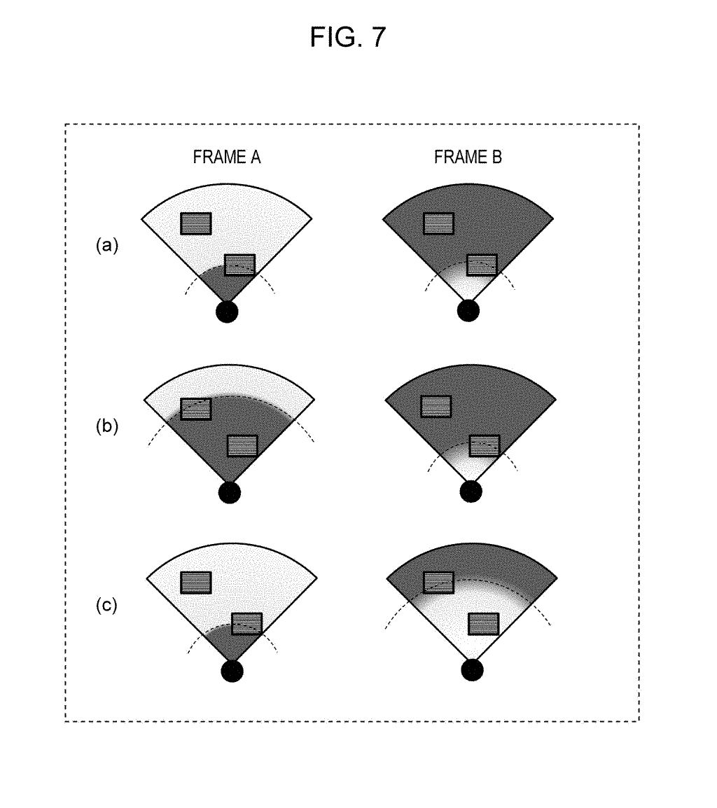

FIG. 7 illustrates schematic views of change in the valid region of the distance value for a distance image that is captured while the light emission amount by the light emitter or the exposure time by the light receiving sensor is changed for every image capturing frame, similar to FIGS. 6(a-3) and 6(b-3).

The change in the image capture condition such as the light emission amount or the exposure time for every image capturing frame causes a region where a valid value for the distance value is obtained from the distance image to be changed. The present example is based on the premise that a distance image is captured while one of image capture conditions of the light emission amount by the light emitter and the exposure time by the light receiving sensor is changed for every image capturing frame. The present example indicates a case where a distance is measured by image-capturing at total two times of a frame A and a frame B with changed image capture conditions. Note that, for simplification, a case where the number of image capturing frames is two is described in this example, however, the number of image capturing frames is not limited to two, but can be set to any number. Moreover, examples illustrated in FIG. 7 indicate a combination of three types of image capture conditions (a), (b), and (c) in the frame A and the frame B.

Views illustrated in FIG. 7 are similar to the views illustrated in FIGS. 6(a-3) and 6(b-3), a black circle, a fan-shaped region, and rectangular areas within the fan-shaped region respectively indicate the light receiving sensor, the angle of view of image capture, and objects. In the fan-shaped region, a colorless region indicates a valid region of a distance value and a colored region indicates an invalid region of a distance value. Moreover, a dashed line of a boundary between the colorless region and the colored region in the fan-shaped region indicates a boundary between the valid region and the invalid region of the distance value.

FIG. 7(a) illustrates a view indicating a case where a boundary between the valid region and the invalid region of the distance value in the frame A is located at the same place as that in the frame B. In this case, of each pixel in the frame A and the corresponding pixel in the frame B, a pixel having a valid value is present only in one of the frames, and thus a distance value of each pixel in the synthesized distance image in which distance values are synthesized is uniquely decided as a distance value indicated in the frame having a valid value.

FIG. 7(b) illustrates a view indicating a case where no overlapping valid region of the distance value is present, but overlapping invalid region of the distance value is present, between the frame A and the frame B. The overlapping invalid region is present between a boundary line between the valid region and the invalid region in the frame A and a boundary line between the valid region and the invalid region in the frame B. A pixel having a valid value for the distance value in any one of the frames has a valid value also in the synthesized distance image, whereas a pixel having an invalid value of the distance value in both the frames has an invalid value in the synthesized distance image.

FIG. 7(c) illustrates a view indicating a case where an overlapping valid region of the distance value is present between the frame A and the frame B. As for a pixel having an invalid value of the distance value in any one of the frames, a distance value in the frame where the pixel has a valid value is applied in the synthesized distance image. As for a pixel having a valid value in both of the frames, a distance value is synthesized in the synthesized distance image. Specifically, out of corresponding pixels in the intensity images in the respective frames, a pixel having a higher intensity value is selected, and a distance value in a pixel of the distance image corresponding to the selected pixel is applied.

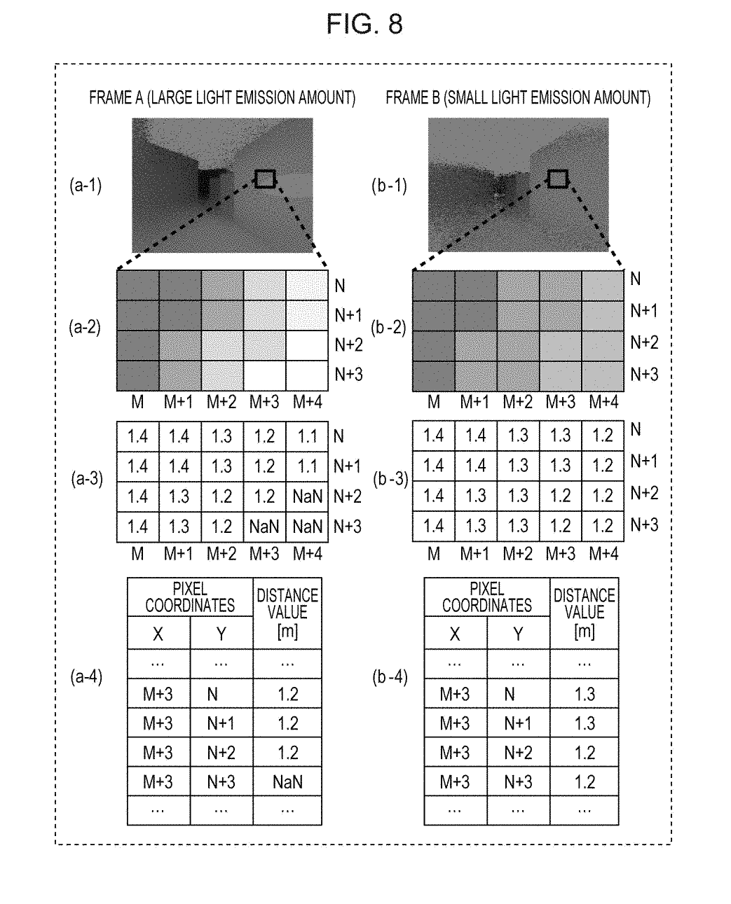

FIG. 8 illustrates views illustrating examples of a data structure of a distance image captured by the distance image generation device 110 according to the embodiment. The present example is based on the premise that a distance image is captured while one of image capture conditions of the light emission amount by the light emitter and the exposure time by the light receiving sensor is changed for every image capturing frame. The present example indicates a case where a distance is measured by image-capturing at total two times of a frame A and a frame B with changed image capture conditions. The distance image is captured in a state where the light emission amount is larger than a predetermined value in the frame A, and is captured in a state where the light emission amount is smaller than a predetermined value in the frame B.

FIG. 8(a-1) illustrates a distance image example in the frame A, and FIG. 8(b-1) illustrates a distance image example in the frame B. FIGS. 8(a-2) and 8(b-2) are enlarged views illustrating the same corresponding pixel regions cut out from the distance images of the frame A and B. The cut-out pixel region corresponds to a pixel region with coordinates (x, y) from (M, N) to (M+4, N+3) in an xy coordinate system that is set on the pixels in the distance image based on the number of pixels. The x coordinate and the y coordinate are respectively integers.

FIGS. 8(a-3) and 8(b-3) respectively indicate tables indicating distance values included in respective pixels within the pixel regions in FIGS. 8(a-2) and 8(b-2). The unit of the distance value is meter. In addition, a distance value “NaN” in the table indicates that the distance value in the pixel is an invalid value.

FIGS. 8(a-4) and 8(b-4) respectively illustrate memory diagrams of the distance values included in the respective pixels in FIGS. 8(a-3) and 8(b-3). As illustrated in these memory diagrams, coordinate values of a pixel and a distance value stored in the coordinates are combined as a pair, and for example, are stored in a memory of the distance image generation device illustrated in FIG. 1.

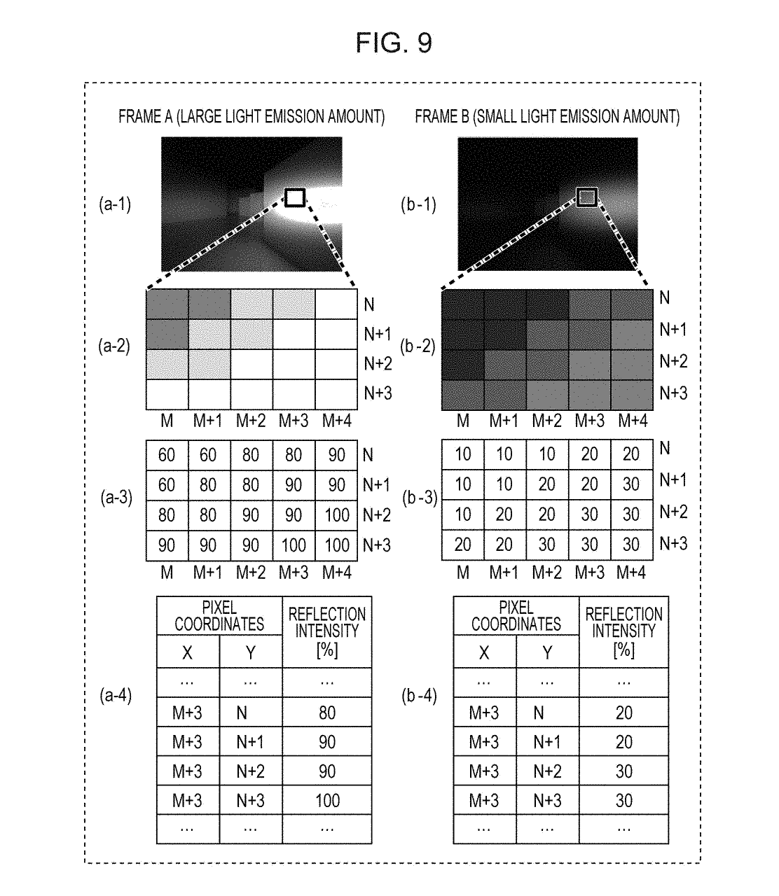

FIG. 9 illustrates views illustrating examples of a data structure of an intensity image captured by the distance image generation device 110 according to the embodiment. The present example is based on the premise that an intensity image is captured while one of image capture conditions of the light emission amount by the light emitter and the exposure time by the light receiving sensor is changed for every image capturing frame. The present example indicates a case where a distance is measured by image-capturing at total two times of a frame A and a frame B with changed image capture conditions. It is assumed that the intensity image is captured in a state where the light emission amount is larger than a predetermined value in the frame A, and is captured in a state where the light emission amount is smaller than a predetermined value in the frame B.

FIG. 9(a-1) illustrates an intensity image example in the frame A, and FIG. 9(b-1) illustrates an intensity image example in the frame B. Moreover, these intensity images are simultaneously acquired when the distance images of FIG. 8 are acquired.

FIGS. 9(a-2) and 9(b-2) are enlarged views illustrating the same corresponding pixel regions cut out from the intensity images of the frame A and B. The cut-out pixel region corresponds to a pixel region with coordinates (x, y) from (M, N) to (M+4, N+3) in an xy coordinate system that is set on the pixels in the intensity image based on the number of pixels. The coordinate system for the intensity image is identical with the coordinate system for the distance image, and the x coordinate and the y coordinate of the intensity are also integers.

FIGS. 9(a-3) and 9(b-3) respectively indicate tables indicating intensity values included in respective pixels within the pixel regions in FIGS. 9(a-2) and 9(b-2). The unit of the intensity value is percent, and the intensity value indicates the ratio of the received reflection light with respect to the projection light, and is also a reflection intensity value.

FIGS. 9(a-4) and 9(b-4) respectively illustrate memory diagrams of the intensity values included in the respective pixels in FIGS. 9(a-3) and 9(b-3). As illustrated in these memory diagrams, coordinate values of a pixel and an intensity value stored in the coordinates are combined as a pair, and for example, are stored in the memory of the distance image generation device illustrated in FIG. 1.

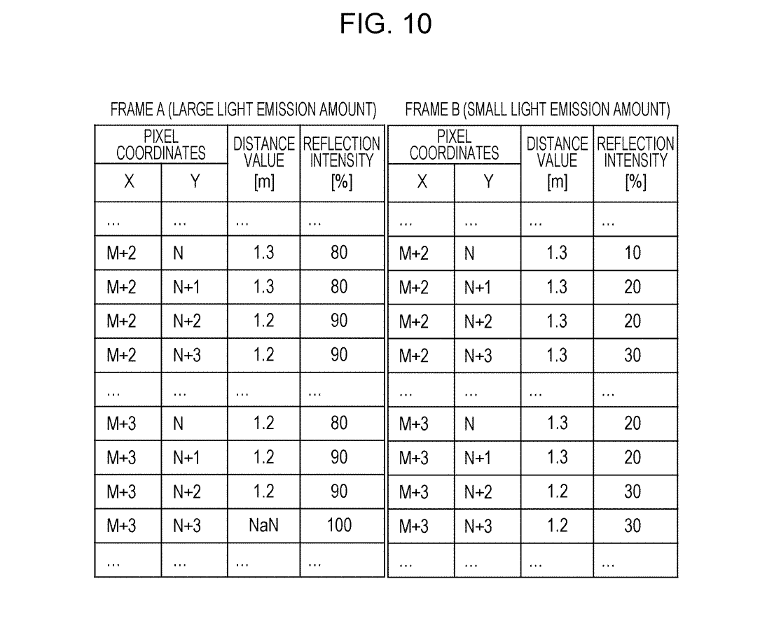

FIG. 10 illustrates memory diagrams each illustrating the data structure of a distance image and an intensity image captured by the distance image generation device 110 according to the embodiment. The diagrams of FIG. 10 are obtained in such a manner that the result in FIG. 8 and the result in FIG. 9 are compiled. As illustrated in these memory diagrams, values included in respective pixels of the distance image and the intensity image are combined for every image capturing frame, and for example, are stored in the memory of the distance image generation device illustrated in FIG. 1. Each pixel in each of the frames is associated with two values of the distance value and the reflection intensity value. For example, when the frame A and the frame B are synthesized in order to generate a synthesized distance image, the distance image generation device 110 refers to the memory for a distance value and a reflection intensity value for each of corresponding pixels between the two frames.

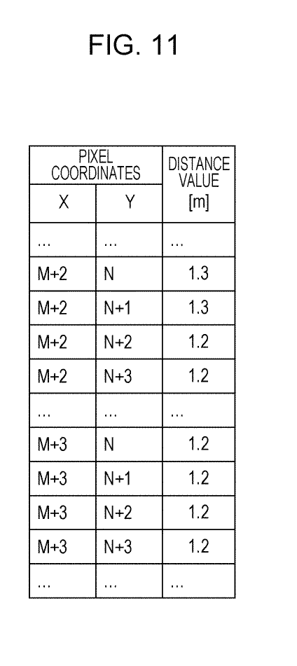

FIG. 11 illustrates a memory diagram illustrating the data structure of a synthesized distance image captured by the distance image generation device 110 according to the embodiment. The present example indicates a memory diagram resulting from the distance images in the frame A and the frame B in FIG. 10 being synthesized. As illustrated in this memory diagram, coordinate values of a pixel and a synthesized distance value of the distance values of the frame A and the frame B in the pixel are combined, and for example, is stored in the memory of the distance image generation device illustrated in FIG. 1. In the process of generating a synthesized distance image, one of the framers A and B is selected based on an intensity difference between the reflection intensity values for each pair of pixels in the frame A and the frame B illustrated in FIG. 10 such that the distance value of the selected frame can be reflected on the corresponding pixel in the synthesized distance image. For example, in a pixel having coordinates (M+2, N+2) illustrated in the present example, distance values of the frame A and the frame B are different from each other. In this case, the distance value of the frame A having stronger reflection intensity is employed, and is reflected to a synthesized distance value of the synthesized distance image. Moreover, in a pixel having coordinates (M+3, N+3), a reflection intensity value of the frame A is 100%, which indicates a saturated state, and a distance value is set as “NaN”, which is an invalid value. Therefore, a distance value of the frame B is employed, and is reflected to a synthesized distance value of the synthesized distance image. In this manner, in the generation of a synthesized distance image, the values of the reflection intensity in pixels in multiple image captured frames are used as keys thereby to select a distance value from the distance image of a single frame. The above procedures are performed for all the pixels of the image captured frames to make it possible to obtain a synthesized distance image.

As in the foregoing, the distance image generation device 110 according to the embodiment extracts a pixel with the higher light receiving intensity from the multiple distance images different in at least one of the light emission amount and exposure time, based on the values of light receiving intensity for the pixels in the distance images, and a synthesized distance image is generated using the extracted pixels. For example, when a moving object is present within a distance image or when the distance image generation device 110 captures a distance image while moving, a position of the object is moved between the multiple images. However, a pixel with the higher light receiving intensity has a higher accuracy of the distance value of the pixel, and thus it is possible to prevent an obscure portion such as blurring from being generated in a synthesized distance image that is synthesized using a pixel of a distance image with the higher light receiving intensity out of corresponding pixels in the multiple distance images. Therefore, a stable distance accuracy is obtained in the synthesized distance image generated by the distance image generation device 110.

Moreover, with the distance image generation device 110 according to the embodiment, a valid pixel is extracted based on the light receiving intensity from the pixels of the distance images, and is used for generation of a synthesized distance image. Further, the valid pixel corresponds to a pixel with the light receiving intensity within a predetermined range. For example, the predetermined range may be a range of the light receiving intensity equal to or higher than a first threshold, may be a range of the light receiving intensity equal to or lower than a second threshold, or may be a range of the light receiving intensity of a first threshold to a second threshold, both inclusive. With this, it is possible to prevent generation of a synthesized distance image using a pixel in which the light receiving intensity of the reflection light is inadequate for calculation of a distance value of the distance image. For example, setting the first threshold to, for example, the low light receiving intensity that does not allow a distance value to be stable acquired can prevent the pixel in the synthesized distance image from having an inaccurate distance. Setting the second threshold to, for example, the saturated light receiving intensity that causes flared highlights in the reflection light can prevent the pixel in the synthesized distance image from having an inaccurate distance.

Moreover, with the distance image generation device 110 according to the embodiment, when only one valid pixel is included in combinations of corresponding pixels among multiple distance images, the one valid pixel is used for the synthesized distance image independent of the light receiving intensity. For example, when only one valid pixel is present in multiple distance images, it is impossible to compare the values of light receiving intensity. In this case, unless the valid pixel is used to form a synthesized distance image, many pixels may be missing in the synthesized distance image. The use of such only one valid pixel in the synthesized distance image, however, can prevent the synthesized distance image from becoming obscure due to missing pixels.

### Other Embodiments

In the foregoing, the distance image generation device according to one or multiple aspects has been described based on the embodiment, however, the present disclosure is not limited to the embodiment. An embodiment in which various modifications that those skilled in the art can consider are applied to the present embodiment or an embodiment that is structured in combination of components in different embodiments may be included within the range of a single or multiple aspects without deviating from the scope of the present disclosure.

The comprehensive or specific aspects may be implemented by a device, a method, an integrated circuit, a computer program or a computer readable recording medium such as a CD-ROM, or be implemented by any arbitrary combination of the device, the method, the integrated circuit, the computer program, and the recording medium.

For example, each component in the image processing apparatus according to the present disclosure may be configured to include a dedicated hardware, or may be implemented by executing a software program appropriate to each component. Each component may be implemented in such a manner that a program executing unit such as a CPU or a processor reads a software program recorded on a recording medium such as a hard disk or a semiconductor memory, and executes it. Note that, each component may be configured by a single element that performs a centralized control, or may be configured by multiple elements that perform a distributed control in cooperation with each other.

Moreover, each component in the image processing apparatus may be a circuit such as a large scale integration (LSI) and a system LSI. Multiple components may configure one circuit as a whole, or may respectively configure different circuits. Moreover, the circuits may respectively be general circuits or dedicated circuits.

The system LSI is an ultra-multifunctional LSI that is produced by integrating multiple constituent units on one chip, and is, specifically, a computer system configured to include a microprocessor, a ROM, a RAM, and the like. A computer program is stored in the RAM. The microprocessor operates in accordance with the computer program to allow the system LSI to attain a function thereof. The system LSI and the LSI may be a field programmable gate array (FPGA) that is programmable after the production of the LSI, or may include a reconfigurable processor that can reconfigure the connection and the setting of circuit cells in the LSI.

Moreover, part or all of components of the image processing apparatus may be configured by an attachable-detachable IC card or a single module. The IC card or the module is a computer system configured to include a microprocessor, a ROM, a RAM, and the like. The IC card or the module may include the abovementioned LSI or system LSI. The microprocessor operates in accordance with the computer program to allow the IC card or the module to attain a function thereof. These IC card and module may include a tamper resistance.

Moreover, an image processing method according to the present disclosure may be implemented by an MPU, a CPU, a processor, a circuit such as an LSI, an IC card, a single module, or the like. Here, the abovementioned image processing method is as follows.

In other words, an image processing method includes: emitting first light and second light at different timings to an object present within an angle of view of image capture, the first light emitted in a first light emission amount for a first exposure time, the second light emitted in a second light emission amount for a second exposure time, at least either the first and second light emission amounts or the first and second exposure times being different from each other; receiving first reflection light which is the first light reflected by the object, and second reflection light which is the second light reflected by the object; calculating a first phase difference indicating a phase difference between the first light and the first reflection light; generating a first distance image representing a distance from the image processing apparatus to the object using the first phase difference; generating a first intensity image in which light receiving intensity of the received first reflection light is represented for each of pixels of the first distance image; calculating a second phase difference indicating a phase difference between the second light and the second reflection light; generating a second distance image representing a distance from the image processing apparatus to the object using the second phase difference; generating a second intensity image in which light receiving intensity of the received second reflection light is represented for each of pixels of the second distance image; comparing the light receiving intensity for each pixel of the first intensity image with the light receiving intensity for the corresponding pixel of the second intensity image; selecting a pixel from each pixel of the first distance image and the corresponding pixel of the second distance image based on the comparison result; and generating a synthesized distance image using the selected pixels.

Moreover, the processing in the image processing apparatus and the image processing method according to the present disclosure may be implemented by a software program or digital signals including the software program. Note that, the abovementioned program and the abovementioned digital signals including the program may be recorded on a computer readable recording medium, for example, a flexible disk, a hard disk, a CD-ROM, an MO, a DVD, a DVD-ROM, a DVD-RAM, a Blu-ray disc (BD (registered trademark)), and a semiconductor memory. Moreover, the abovementioned program and the abovementioned digital signals including the program may be transmitted via an electric communication channel, a wire or wired communication channel, a network such as the Internet as a representative, a data broadcast, or the like. Moreover, the abovementioned program and the abovementioned digital signals including the program may be executed by a separate another computer system, by being recorded on the recording medium and transferred via the network or the like. Here, the abovementioned software is a program as follows.

In other words, a non-transitory recording medium stores an image processing program. The program causes a processor to: emit first light and second light at different timings to an object present within an angle of view of image capture, the first light emitted in a first light emission amount for a first exposure time, the second light emitted in a second light emission amount for a second exposure time, at least either the first and second light emission amounts or the first and second exposure times being different from each other; receive first reflection light which is the first light reflected by the object, and second reflection light which is the second light reflected by the object; calculate a first phase difference indicating a phase difference between the first light and the first reflection light; generate a first distance image representing a distance from the image processing apparatus to the object using the first phase difference; generate a first intensity image in which light receiving intensity of the received first reflection light is represented for each of pixels of the first distance image; calculate a second phase difference indicating a phase difference between the second light and the second reflection light; generate a second distance image representing a distance from the image processing apparatus to the object using the second phase difference; generate a second intensity image in which light receiving intensity of the received second reflection light is represented for each of pixels of the second distance image; compare the light receiving intensity for each pixel of the first intensity image with the light receiving intensity for the corresponding pixel of the second intensity image; select a pixel from each pixel of the first distance image and the corresponding pixel of the second distance image based on the comparison result; and generate a synthesized distance image using the selected pixels.

What is claimed is:

1. An image processing apparatus comprising:
a light emitter that emits first light and second light at different timings towards an object present within an angle of view of the image processing apparatus, the first light emits a first light emission amount for a first exposure time, the second light emits a second light emission amount for a second exposure time, and the first and second light emission amounts or the first and second exposure times are different from each other;
a light receiving sensor that receives first reflection light which is the first light reflected by the object, and second reflection light which is the second light reflected by the object; and
a processor that
calculates a first phase difference between the first light and the first reflection light,
generates a first distance image using the first phase difference,
generates a first intensity image in which light receiving intensity of the first reflection light received by the light receiving sensor is represented for each pixel of the first distance image,
calculates a second phase difference between the second light and the second reflection light,
generates a second distance image using the second phase difference,
generates a second intensity image in which light receiving intensity of the second reflection light received by the light receiving sensor is represented for each pixel of the second distance image,
compares the light receiving intensity for each pixel of the first intensity image with the light receiving intensity for a corresponding pixel of the second intensity image,
selects a pixel from the first distance image and a corresponding pixel of the second distance image based on the comparison, and
generates a synthesized distance image using the selected pixels.

2. The image processing apparatus according to claim 1, wherein the processor further
extracts a first pixel from the first distance image, the first pixel corresponding to a pixel having light receiving intensity of the first reflection light within a predetermined range in the first intensity image,
extracts a second pixel from the second distance image, the second pixel corresponding to a pixel having light receiving intensity of the second reflection light within the predetermined range in the second intensity image,
compares the light receiving intensity within the predetermined range for the first pixel with the light receiving intensity within the predetermined range for the second pixel,
based on the comparison, selects a pixel having higher light receiving intensity from the first pixel and the second pixel when both of the first pixel and the second pixel are valid pixels, and
generates the synthesized distance image using the selected pixel having the higher light receiving intensity.

3. The image processing apparatus according to claim 2, wherein
based on the comparison, when only one of the first pixel and the second pixel is a valid pixel, the processor generates the synthesized distance image using the valid pixel among the first pixel and the second pixel.

4. The image processing apparatus according to claim 2, wherein
the predetermined range is equal to or more than a first threshold.

5. The image processing apparatus according to claim 2, wherein
the predetermined range is equal to or less than a second threshold.

6. The image processing apparatus according to claim 2, wherein
the predetermined range is a range between a first threshold to a second threshold, both inclusive.

7. An image processing method comprising:
emitting first light and second light at different timings towards an object present within an angle of view of image capture, the first light emitting in a first light emission amount for a first exposure time, the second light emitting in a second light emission amount for a second exposure time, and the first and second light emission amounts or the first and second exposure times are different from each other;
receiving first reflection light which is the first light reflected by the object, and second reflection light which is the second light reflected by the object;
calculating a first phase difference between the first light and the first reflection light;
generating a first distance image using the first phase difference;
generating a first intensity image in which light receiving intensity of the received first reflection light is represented for each pixel of the first distance image;
calculating a second phase difference between the second light and the second reflection light;
generating a second distance image using the second phase difference;
generating a second intensity image in which light receiving intensity of the received second reflection light is represented for each pixel of the second distance image;
comparing the light receiving intensity for each pixel of the first intensity image with the light receiving intensity for a corresponding pixel of the second intensity image;
selecting a pixel from the first distance image and a corresponding pixel of the second distance image based on the comparison; and
generating a synthesized distance image using the selected pixels.

8. A non-transitory recording medium storing an image processing program,
the program causes a processor to:
emit first light and second light at different timings towards an object present within an angle of view of image capture, the first light emits in a first light emission amount for a first exposure time, the second light emits in a second light emission amount for a second exposure time, and the first and second light emission amounts or the first and second exposure times are different from each other;
receive first reflection light which is the first light reflected by the object, and second reflection light which is the second light reflected by the object;
calculate a first phase difference between the first light and the first reflection light;
generate a first distance image using the first phase difference;
generate a first intensity image in which light receiving intensity of the received first reflection light is represented for each pixel of the first distance image;
calculate a second phase difference between the second light and the second reflection light;
generate a second distance image using the second phase difference;
generate a second intensity image in which light receiving intensity of the received second reflection light is represented for each pixel of the second distance image;
compare the light receiving intensity for each pixel of the first intensity image with the light receiving intensity for a corresponding pixel of the second intensity image;
select a pixel from the first distance image and a corresponding pixel of the second distance image based on the comparison; and
generate a synthesized distance image using the selected pixels.
